(19) United States
(12) Patent Application Publication
(10) Pub. No.: US 2005/0018083 A1
(43) Pub. Date: Jan. 27, 2005

(54) Apparatus and method of changing a sub-picture into a main picture

(76) Inventor: Kye-won Ryou, Seoul (KR)

Correspondence Address: STANZIONE & KIM, LLP, 1740 N STREET, N.W., FIRST FLOOR, WASHINGTON, DC, 20036, US

(21) Appl. No.: 10/876,635

(22) Filed: Jun. 28, 2004

(30) Foreign Application Priority Data
Jul. 26, 2003 (KR) 2003-51843

(51) Int. Cl. H04N 5/445

(52) U.S. Cl. 348/565

(57) ABSTRACT

An apparatus and method to change a sub-picture to be a main picture when a synchronous signal of the main picture is not detected while displaying multiple pictures. The method includes scaling predetermined first and second video signals selected from video signals input from an external source not included in the display apparatus so that the first and second video signals are respectively the main picture and the sub-picture to be displayed in a multi-picture mode, detecting whether the synchronous signal of the first video signal exists, and scaling the second video signal from the sub-picture to be the main picture if a synchronous signal of the first video signal is not detected. Even when a synchronous signal of a main picture is not detected while a user is viewing the sub-picture, a status of the sub-picture is changed to be that of the main picture and is displayed. Therefore, the user can continue to view the sub-picture.

### CROSS-REFERENCE TO RELATED APPLICATIONS

This application claims the priority of Korean Patent Application No. 2003-51843, filed on Jul. 26, 2003, in the Korean Intellectual Property Office, the disclosure of which is incorporated herein in its entirety by reference.

### BACKGROUND OF THE INVENTION

1. Field of the Invention

The present general inventive concept relates to a display apparatus and method, and more particularly, to an apparatus and method to change a sub-picture to be a main picture when a synchronous signal of the main picture is not detected while displaying multiple pictures.

2. Description of the Related Art

Televisions (TVs) supply to users image information sent by satellite, cable, and land based broadcast stations. The broadcast information can be stored in information storage devices such as built-in hard disks, and recorded in predetermined recording media. Further, information can be supplied and searched by connecting a TV to a communication network such as the Internet.

Most TVs include video interfaces connecting the TVs to video input signals. When a user is watching a video produced by a video signal received through a video interface and wants to watch another video produced by a video signal received through another video interface, the user can change an input/output path of the video signal by accessing an on-screen-display (OSD) with a television keyboard or a remote controller.

Conventional methods of displaying two pictures simultaneously include a picture in picture (PIP) method and a picture by picture (PBP) method.

FIG. 1a illustrates a picture displayed using the PIP method. In the PIP method, a sub-picture is displayed as a small sized picture within a main picture that fills a whole display. If the PIP method is used, an image produced by a video signal including the main picture fills the whole display while an image produced by a video signal including the sub-picture is displayed in a portion of the whole display.

FIG. 1b illustrates a picture displayed using the PBP. In the PBP method, the whole display is divided in two, with a first sub-picture 1 and a second sub-picture 2 respectively displayed in the two halves of the display. That is, in the PBP method, an image produced by a video signal including the first sub-picture 1 and an image produced by a video signal including the second sub-picture 2 are each displayed on half of the display.

A description of a multi-picture display is disclosed in U.S. patent Publication No. 6,515,643.

In the PIP display method illustrated by FIG. 1a, it is assumed that a PC signal includes the main picture and a TV signal includes the sub-picture. If a synchronous signal of the PC signal is deactivated due to the activation of a power save mode of the PC while displaying multiple pictures, the display apparatus enters the power save mode and the main picture and the sub-picture are not displayed though a synchronous signal of the TV signal is not deactivated.

In conventional display apparatuses, since a multi-picture display is displayed based on the synchronous signal of the main picture, if the synchronous signal of the main picture is deactivated while displaying the multiple pictures, all of the pictures disappear without considering a synchronous signal of the sub-picture.

### SUMMARY OF THE INVENTION

Accordingly, it is an aspect of the present general inventive concept to provide an apparatus that changes a sub-picture to be a main picture when a synchronous signal of the main picture is not detected while displaying multiple pictures.

It is a further aspect of the present general inventive concept to provide a method to change a sub-picture to be a main picture when a synchronous signal of the main picture is not detected while displaying multiple pictures.

Additional aspects and advantages of the present general inventive concept will be set forth in part in the description which follows and, in part, will be obvious from the description, or may be learned by practice of the invention.

The foregoing and/or other aspects of the present general inventive concept are achieved by providing a display apparatus to change a sub-picture to be a main picture, the apparatus including: a video interface unit to receive a predetermined first and second video signals selected from video signals input from an external source; a scaling unit to scale the first and second video signals so that the first and second video signals are respectively the main picture and the sub-picture to be displayed in a multi-picture mode and in response to a scaling control signal, scales the sub-picture to be the main picture; and a control unit to control scaling operations on the first and second video signals and outputs the scaling control signal if a synchronous signal of the first video signal is not detected.

The control unit can further include a synchronous signal detector which detects whether the synchronous signal of the first video signal exists.

The control unit can further include a power save mode changer, which switches the apparatus to a power save mode if the first video signal is a PC signal, the second video signal is not displayed, and a synchronous signal of the first video signal is not detected.

According to another aspect of the present general inventive concept, there is provided a display apparatus to change a sub-picture to be a main picture, the apparatus including: a video interface unit to receive a predetermined first and second video signals selected from video signals input from an external source; and a scaling unit to scale the first and second video signals so that the first and second video signals are respectively the main picture and the sub-picture to be displayed in a multi-picture mode and if a synchronous signal of the first video signal is not detected, scales the sub-picture to be the main picture.

The scaling unit can include: a scaler to scale the first and second video signals so that the first and second video signals are displayed as the main picture and the sub-picture; a synchronous signal detector to detect whether the synchronous signal of the first video signal exists; and a controller to control the scaler to scale the second video signal to be the main picture if a synchronous signal of the first video signal is not detected.

The scaling unit can further include a power save mode changer to switch the apparatus to a power save mode if the first video signal is a PC signal, the second video signal is not displayed, and a synchronous signal of the first video signal is not detected.

According to another aspect of the present general inventive concept, there is provided a method to change a sub-picture to be a main picture in a display apparatus, the method including: scaling predetermined first and second video signals selected from video signals input from an external source not included in the display apparatus so that the first and second video signals are respectively the main picture and the sub-picture to be displayed in a multi-picture mode; detecting whether the synchronous signal of the first video signal exists; and scaling the second video signal from the sub-picture to be the main picture if a synchronous signal of the first video signal is not detected.

The above method can further include: switching the apparatus to a power save mode if the first video signal is a PC signal, the second video signal is not displayed, and the synchronous signal of the first video signal is not detected.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates pictures displayed using conventional multi-picture display methods;

FIG. 2 is a block diagram of an apparatus that changes a sub-picture to be a main picture according to a first exemplary embodiment of the present general inventive concept;

FIG. 3 is a block diagram of an apparatus that changes a sub-picture to be a main picture according to a second exemplary embodiment of the present general inventive concept; and

FIG. 4 is a flowchart of a method of changing a sub-picture to be a main picture according to a third exemplary embodiment of the present general inventive concept.

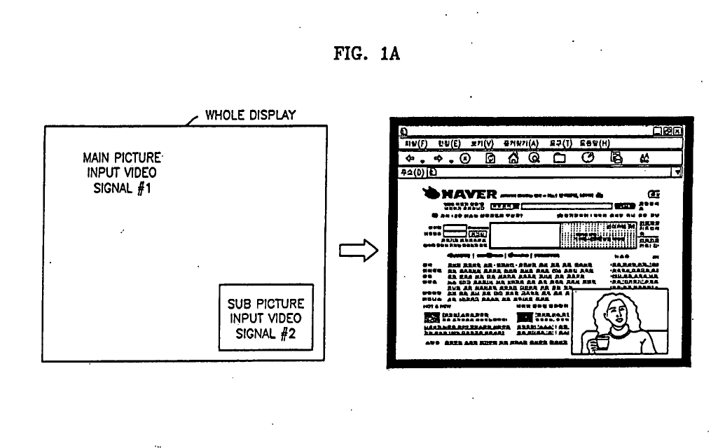

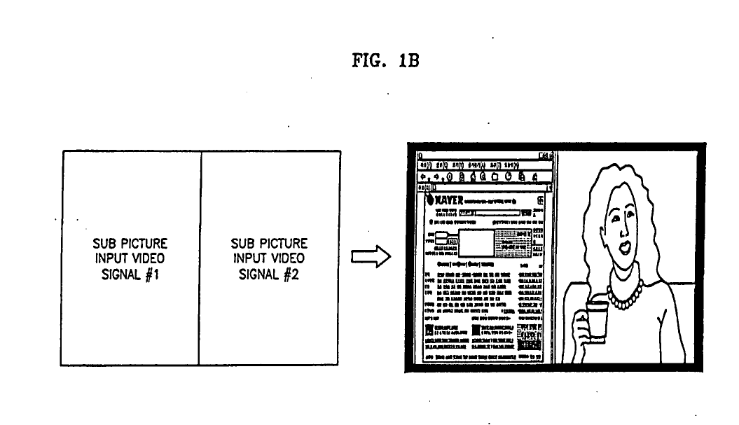

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

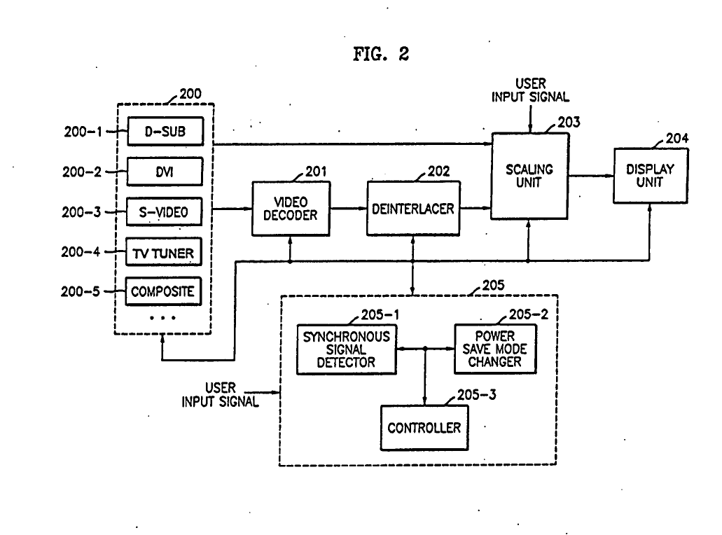

FIG. 2 is a block diagram of an apparatus that changes a sub-picture to be a main picture according to an embodiment of the present general inventive concept.

With reference to FIG. 2, the apparatus can include a video interface unit 200, a video decoder 201, a deinterlacer 202, a scaling unit 203, a display unit 204, and a control unit 205.

The video interface unit 200 includes a D-SUB connector 200-1, a digital video interactive (DVI) connector 200-2, a separate (S) video connector 200-3, a TV tuner connector 2004, and a composite connector 200-5. The control unit 205 includes a synchronous signal detector 205-1, a power save mode changer 205-2, and a controller 205-3.

The apparatus that changes a sub-picture into a main picture according to this embodiment will now be described in detail with reference to FIG. 2.

The video interface unit 200 can receive input signals from external devices. In the present general inventive concept, the video interface unit 200 can receive video signals transmitted from three external devices (a PC, a game device, and a TV). However, the number of external devices is not limited to three.

The video interface unit 200 can receive video signals transmitted from the PC (not shown) through the D-Sub connector 200-1 and the DVI connector 200-2. The video interface unit 200 can receive video signals transmitted from the game device (not shown) through the S-video connector 200-3. The S-video signal can include a luminance (Y) signal and a chroma (C) signal. The C signal produces two chrominance signals from a component signal using a phase modulation method. In the S-video, the Y signal and the C signal separate from a composite signal. S-videos can produce high quality videos more efficiently than composite videos. Usually, a connector including four pins can be connected to the S-video connector 200-3 through a dedicated line. The video interface unit 200 receives video signals transmitted from the TV (not shown) through the TV tuner connector 2004 and the composite connector 200-5.

When multiple pictures are displayed, the video interface unit 200 can output a first video signal and a second video signal in response to the control unit 205. The first and second video signals can be any two signals among video signals output from the D-SUB connector 200-1, the DVI connector 200-2, the S-video connector 200-3, the TV tuner connector 2004, and the composite connector 200-5.

The video signals transmitted from the PC through the D-Sub connector 200-1 and the DVI connector 200-2 are output directly to the scaling unit 203. However, the video signal transmitted from the game device through the S-video connector 200-3 and the signals transmitted from the TV through the TV tuner connector 2004 and the composite connector 200-5 are output to the video decoder 201.

The video decoder 201 can decode the video signals transmitted from the video interface unit 200 that are received via the S-video connector 200-3, the TV tuner connector 2004 and the composite connector 200-5, and can output the decoded video signals to the deinterlacer 202.

The deinterlacer 202 can deinterlace the decoded video signals and can output the deinterlaced signal to the scaling unit 203.

The scaling unit 203 can convert a resolution of the video signals to a resolution suited for the display unit 204, can adjust video quality settings, and can output the converted signals to the display unit 204. If a user selects a signal to display multiple pictures, the scaling unit 203 can perform a scaling operation on the video signal to display the multiple pictures in response to the control unit 205. The scaling unit 203 can also scale a sub-picture to be a main picture in response to the control unit 205 thereby changing the sub-picture to be the main picture.

The control unit 205 can control the scaling of the first and second video signals according to a picture selection signal input by the user. If the first video signal is selected as a main picture and a synchronous signal of the first video signal is not detected, the control unit 205 outputs a scaling control signal to the scaling unit 203 causing the scaling unit 203 to scale the second video signal to be the main picture. The control unit 205 can include the synchronous signal detector 205-1, the power save mode change unit 205-2, and the controller 205-3.

The controller 205-3 can receive a multi-picture display signal from the user through a keypad (not shown) or a remote controller (not shown). Next, the controller 205-3 can output an on screen display (OSD) menu to the display unit 204. The OSD menu allows the user to select the PIP or the PBP method to display multiple pictures. The controller 205-3 also receives a first video selection signal, which selects the main picture, and a second video selection signal, which selects the sub-picture.

The first and second video signals, which are the main picture and sub-picture, respectively, are video signals input via the D-SUB connector 200-1, the DVI connector 200-2, the S-video connector 200-3, the TV tuner connector 2004, or the composite connector 200-5, but not necessary input via the same connector.

When the multi-picture display is selected, the main picture and the sub-picture are displayed on the display unit 204 at the same time. While the multi-picture is being displayed, the synchronous signal detector 205-1 detects whether a synchronous signal of the first video signal, which is the main picture, exists.

If the synchronous signal of the first video signal is detected by the synchronous signal detector 205-1, the controller 205-3 can continue to maintain the present multi-picture status. However, if the synchronous signal of the first video signal is not detected by the synchronous signal detector 205-1, the controller 205-3 can change the status of the second video signal, which is the sub-picture, to be the main picture, and can output a scaling control signal to the scaling unit 203, which then can scale the second video signal to be the main picture.

If the first video signal selected as the main picture is a PC signal, and the second video signal selected as the sub-picture is not displayed, and a synchronous signal of the first video signal is not detected by the synchronous signal detector 205-1, then the power save mode changer 205-2 switches the display apparatus to a power save mode. When the display apparatus is in the power save mode, power may only be supplied to the controller 205-3.

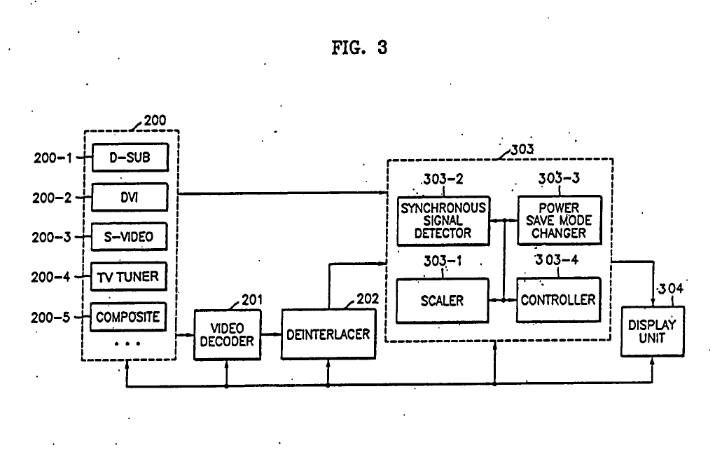

FIG. 3 is a block diagram of an apparatus that changes a sub-picture to be a main picture according to another exemplary embodiment of the present general inventive concept.

With reference to FIG. 3, the apparatus can include a video interface unit 200, a video decoder 201, a deinterlacer 202, a scaling unit 303, and a display unit 204.

The video interface unit 200 can include a D-SUB connector 200-1, a digital video interactive (DVI) connector 200-2, a separate (S) video connector 200-3, a TV tuner connector 2004, and a composite connector 200-5. The scaling unit 303 includes a scaler 303-01, a synchronous signal detector 303-2, a power save mode changer 303-3, and a controller 3034.

The apparatus to change a sub-picture to be a main picture according to this embodiment of the present general inventive concept will now be described in detail with reference to FIG. 3.

While the first exemplary embodiment includes the control unit 205 separate from the scaling unit 203, this embodiment can include the controller 3034 in the scaling unit 303. Since the video interface unit 200, the video decoder 201, the deinterlacer 202, and the display unit 204 are all the same as those in the previous embodiment, a detailed description thereof will be omitted.

The video interface unit 200 can receive video signals transmitted from the PC (not shown) through the D-Sub connector 200-1 and the DVI connector 200-2, video signals transmitted from the game device (not shown) through the S-video connector 200-3, and video signals transmitted from the TV (not shown) through the TV tuner connector 2004 and the composite connector 200-5. When multiple pictures are displayed by the display unit 204, the video interface unit 200 can output a first video signal and a second video signal in response to the controller 3034.

The video decoder 201 can decode the video signals transmitted from the video interface unit 200 via the S-video connector 200-3, the TV tuner connector 2004 or the composite connector 200-5, and can output the decoded video signal to the deinterlacer 202.

The deinterlacer 202 can deinterlace the decoded video signal and can output the deinterlaced signal to the scaling unit 303.

The scaling unit 303 can scale the deinterlaced video signals to display the first and second video signals as multiple pictures including the main picture and the sub-picture. If the first video signal is selected as the main picture and a synchronous signal of the first video signal is not detected, the scaling unit 203 can then scale the second video signal, which is selected as the sub-picture, to be the main picture, and outputs the scaled second video signal to the display unit 204. To perform this operation, the scaling unit 303 can include the scaler 303-1, the synchronous signal detector 303-2, the power save mode changer 303-3, and the controller 3034.

The scaler 303-1 can convert resolutions of the input video signals to resolutions suited for the display unit 204, can adjust video quality settings, and can output the converted signals to the display unit 204. If a user selects a signal to display multiple pictures, the scaler 303-1 can perform a scaling operation on the video signal to display the multiple pictures in response to the controller 3034. The scaler 303-1 also can scale a sub-picture to be a main picture in response to the controller 3034 thereby changing the sub-picture to be the main picture.

The controller 3034 can control the scaling of the first and second video signals according to a picture selection signal input by the user. If the first video signal is selected and a synchronous signal of the first video signal is not detected, the controller 3034 can output a scaling control signal to the scaler 303-1 causing the scaler 303-1 to scale the second video signal to be the main picture.

The controller 3034 can receive a multi-picture display signal from the user through a keypad (not shown) or a remote controller (not shown). Next, the controller 3034 can output on a screen display (OSD) menu to the display unit 204. The OSD menu can allow the user to select the PIP or PBP method to display multiple pictures. The controller 3034 can also receive a first video selection signal, which selects the main picture, and a second video selection signal, which can select the sub-picture.

The first and second video signals, which are the main picture and sub-picture, respectively, are video signals input via the D-SUB connector 200-1, the DVI connector 200-2, the S-video connector 200-3, the TV tuner connector 2004, or the composite connector 200-5, but not necessary input via the same connector.

When the multi-picture display is selected, the main picture and the sub-picture are displayed on the display unit 204 at the same time. While the multi-picture is being displayed, the synchronous signal detector 303-2 can detect whether a synchronous signal of the first video signal, which is the main picture, exists.

If the synchronous signal of the first video signal is detected by the synchronous signal detector 303-2, the controller 3034 continues to maintain the present multi-picture status. However, if the synchronous signal of the first video signal is not detected by the synchronous signal detector 303-2, the controller 3034 can change the status of the second video signal, which is the sub-picture, to be the main picture, and can output a scaling control signal to the scaler 303-1, which can then scale the second video signal to be the main picture.

If the first video signal, selected as the main picture, is a PC signal, the second video signal, selected as the sub-picture, is not displayed and a synchronous signal of the first video signal is not detected by the synchronous signal detector 303-2, then the power save mode changer 303-3 switches the display apparatus to a power save mode. When the display apparatus is in the power save mode, power may only be supplied to the controller 3034.

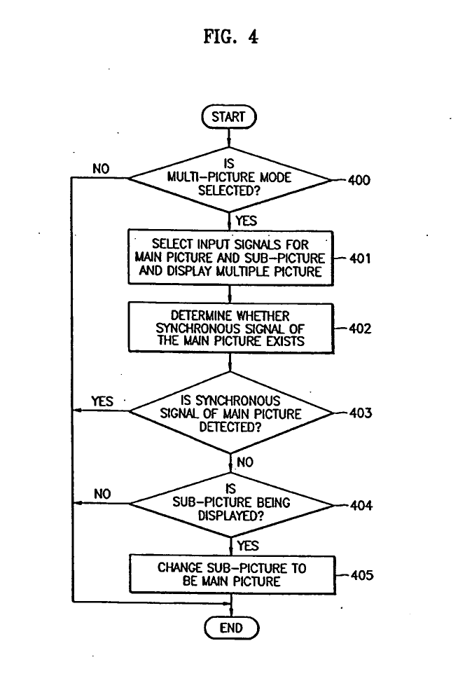

The method of changing a sub-picture to be a main picture according to another embodiment of the present general inventive concept will now be described in detail with reference to FIGS. 2 and 4.

In operation 400, the controller 205-3 determines whether a multi-picture mode is selected according to a multi-picture selecting signal.

In operation 401, the controller 205-3 receives the multi-picture selection signal and selects an input video signal for each of the main picture and the sub-picture of the multiple pictures and controls signal processing to display the multiple pictures. The video interface unit 200 receives video signals transmitted from a PC (not shown) through the D-Sub connector 200-1 and the DVI connector 200-2, video signals transmitted from a game device (not shown) through the S-video connector 200-3, and video signals transmitted from a TV (not shown) through the TV tuner connector 2004 and the composite connector 200-5. When multiple pictures are displayed, the video interface unit 200 can output a first video signal and a second video signal in response to the controller 205-3. The video decoder 201 decodes the video signals received from the video interface unit 200 via the S-video connector 200-3, the TV tuner connector 2004 or the composite connector 200-5, and outputs the decoded video signals to the deinterlacer 202. The deinterlacer 202 deinterlaces the decoded video signals and outputs the deinterlaced signal to the scaling unit 203. The scaling unit 203 can convert a resolution of the video signals to a resolution suited for the display unit 204, can adjust video quality settings, and can output the converted signals to the display unit 204. If a user selects a signal to display multiple pictures, the scaling unit 203 can perform a scaling operation on the video signal to display the multiple pictures in response to the controller 205-3. The scaling unit 203 can also scale a sub-picture to be a main picture in response to the controller 205-3, thereby changing the sub-picture to be the main picture.

In operation 402, while the multiple pictures are being displayed, the synchronous signal detector 205-1 determines whether a synchronous signal from the first video signal exists.

If the synchronous signal of the first video signal is detected by the synchronous signal detector 205-1 in operation 403, the controller 205-3 maintains the current multi-picture mode. In operation 403, if the synchronous signal of the first video signal is not detected, the controller 205-3 determines whether the second video signal selected as the sub-picture is being displayed in operation 404.

If the second video signal is being displayed, the controller 205-3 can change the status of the second video signal from the sub-picture to be the main picture, in operation 405, and outputs a scaling control signal to the scaling unit 203 to cause the scaling unit 203 to scale the second video signal to be the main picture.

If the first video signal, selected as the main picture, is a PC signal, the second video signal, selected as the sub-picture, is not displayed, and a synchronous signal of the first video signal is not detected by the synchronous signal detector 205-1, then the power save mode changer 205-2 switches the display apparatus to a power save mode. When the display apparatus is in the power save mode, power is only supplied to the controller 205-3.

As described above, when a synchronous signal of a main picture is not detected while a user is viewing a sub-picture of a multi-picture mode, the sub-picture can be changed to be a main picture and can continue to be displayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display apparatus to change a sub-picture to be a main picture, the apparatus comprising:
a video interface unit to receive predetermined first and second video signals selected from video signals input from an external source;
a scaling unit to scale the first and second video signals so that the first and second video signals are respectively a main picture and a sub-picture to be displayed in a multi-picture mode, and in response to a scaling control signal, scales the sub-picture to be the main picture; and
a control unit to control scaling operations on the first and second video signals and to output the scaling control signal if a synchronous signal of the first video signal is not detected.

2. The apparatus of claim 1, wherein the control unit further comprises a synchronous signal detector, to detect whether the synchronous signal of the first video signal exists.

3. The apparatus of claim 1, wherein the control unit further comprises a power save mode changer to switch the apparatus to a power save mode if the first video signal is a PC signal, the second video signal is not displayed, and a synchronous signal of the first video signal is not detected.

4. A display apparatus to change a sub-picture to be a main picture, the apparatus comprising:
a video interface unit to receive predetermined first and second video signals selected from video signals input from an external source; and
a scaling unit to scale the first and second video signals so that the first and second video signals are respectively a main picture and a sub-picture to be displayed in a multi-picture mode, and if a synchronous signal of the first video signal is not detected, scales the sub-picture to be the main picture.

5. The apparatus of claim 4, wherein the scaling unit comprises:
a scaler to scale the first and second video signals so that the first and second video signals are displayed as the main picture and the sub-picture;
a synchronous signal detector to detect whether the synchronous signal of the first video signal exists; and
a controller to control the scaler to scale the second video signal to be the main picture if a synchronous signal of the first video signal is not detected.

6. The apparatus of claim 5, wherein the scaling unit further comprises a power save mode changer to switch the apparatus to a power save mode if the first video signal is a PC signal, the second video signal is not displayed, and a synchronous signal of the first video signal is not detected.

7. An apparatus to change pictures to be displayed on a display unit, the apparatus comprising:
a signal detector to detect a first video signal; and
a controlling unit to output a scaling control signal to control the second video signal to be scaled in a first resolution and to output the second video signal as a main picture, when the signal detector does not detect the first video signal.

8. The apparatus of claim 7, wherein the first video signal is scaled into the first resolution and the second video signal is scaled into a second resolution, the first resolution being a size of a main picture, and the second resolution being a size of a picture within a picture.

9. The apparatus of claim 7, further comprising a power save mode changer connected to the signal detector to switch the apparatus to a power save mode if the first video signal is a PC signal, the second video signal is not output, and a signal of the first video signal is not detected.

10. An apparatus to change pictures to be displayed in a display unit, the apparatus comprising:
a scaling unit to output a combined video signal having a first video signal scaled in a first resolution and a second video signal scaled in a second resolution; and
a controlling unit to control the scaling unit to output the second video signal scaled in the first resolution when the first video signal is not detected.

11. An apparatus as recited in claim 10, wherein the first resolution is a size of a main picture, and the second resolution is a size of a picture within a picture.

12. An apparatus as recited in claim 10, further comprising a power save mode changer connected to the scaling unit to switch the apparatus to a power save mode if the first video signal is a PC signal, the second video signal is not output, and a synchronous signal of the first video signal is not detected.

13. A method of changing a sub-picture to be a main picture in a display apparatus, the method comprising:
scaling predetermined first and second video signals selected from video signals input from an external source not included in the display apparatus so that the first and second video signals are respectively the main picture and the sub-picture to be displayed in a multi-picture mode;
detecting whether a synchronous signal of the first video signal exists; and
scaling the second video signal from the sub-picture to be the main picture if the synchronous signal of the first video signal is not detected.

14. The method of claim 13, further comprising:
switching the apparatus to a power save mode if the first video signal is a PC signal, the second video signal is not displayed, and the synchronous signal of the first video signal is not detected.

15. A method of changing pictures to be displayed in a display unit, the method comprising:
detecting whether a first video signal exists;
outputting a scaling control signal, when the first video signal is not detected; and
scaling a second video signal in a first resolution and outputting the second video signal as a main picture when the scaling control signal is output.

16. The method of claim 15, wherein the first video signal is scaled into the first resolution and the second video signal is scaled into a second resolution, the first resolution being a size of a main picture, and the second resolution being a size of a picture within a picture.

17. The method of claim 15, further comprising switching the apparatus to a power save mode if the first video signal is a PC signal, the second video signal is not output, and a synchronous signal of the first video signal is not detected.

18. A method of changing pictures to be displayed in a display unit, the method comprising:
outputting a combined video signal having a first video signal scaled in a first resolution and a second video signal scaled in a second resolution;
detecting whether the first video signal is present; and
switching the second video signal to the first resolution if a synchronous signal of the first video signal is not detected.

19. The method of claim 18, wherein the first resolution is a size of a main picture, and the second resolution is a size of a picture within a picture.

20. The method of claim 18, further comprising switching to a power save mode if the first video signal is a PC signal, the second video signal is not output, and a synchronous signal of the first video signal is not detected.
